(19) United States
(12) Patent Application Publication
(10) Pub. No.: US 2007/0070444 A1
(43) Pub. Date: Mar. 29, 2007

(54) Image reading apparatus and image forming apparatus

(75) Inventors: Jun Sakakibara, Tokyo (JP); Koji Tanimoto, Shizuoka-Ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/221,981

(22) Filed: Sep. 9, 2005

(51) Int. Cl. H04N 1/04

(52) U.S. Cl. 358/474; 358/450

(57) ABSTRACT

There is provided an image reading apparatus optically reading a document image to produce image data of the document image. This apparatus comprises a first line sensor performing the optical reading and having a predetermined number of pixels and a second line sensor performing the optical reading and having the number of pixels larger than the predetermined number of pixels. In this apparatus, using both of first image information outputted from the first line sensor and second image information outputted from the second line sensor, third image information reflecting resolution of the second image information is produced. Pieces of the first and third image information are then subjected to application of compression, the compression applied to the first image information and that to the third image information being mutually. Resultant pieces of the first and third image information are mutually synthesized to produce the image data of the document image.

### BACKGROUND OF THE INVENTION

1. Technical Field of the Invention

The present invention relates to an image reading apparatus that reads out document images expressed in colors and/or in black and white, and an image forming apparatus with such an image reading apparatus.

2. Related Art

In recent years, network systems that have come into wide use, which necessitates busy communications where document image data, when produced, are transmitted via networks and then such document image data via networks are stored after completion of the transmission. Further, handling document images in the form of electronic data, which is for example output of document image data using network printers, has been generalizing. In addition to such a situation, the prices of cooler printers and color digital copying machines have been decreased gradually, which is accelerating colorizing of document images at a rapid pace.

Colorizing document images leads to an increase in the amount of information thereof, whereby the colorization has been indispensable in a presentation meeting. At the same time, coloring document images has the drawback that the volume of electronic data to be handled becomes considerably large. Handling such a large-volume electronic data will cause client PCs (personal computers) to have an increase amount of calculation load and networks to have an increased amount of communication load. To compensate these drawbacks, the compression of electronic data has been essential.

Concerning such compression techniques, some techniques are known, whose use are on the increase, by which all the image region given by a document image is separated into an image region containing photographs produced in halftone and an line-art region containing characters and thin lines, and both of the image region and the line-art region are compressed separately. This compression provides high compression rates, with information in relation to the original image still maintained. Of these techniques, the regional separation technique has already been reported in the field related to images in such associations as the Institute of Image Electronics Engineers of Japan(refer to “Ricoh Technical Report No. 30, “Compact PDF Technology,” December, 2004” and Japanese Patent Laid-open publication No. 2-274174). In addition, concerning with the compression, there has been known that individually compressing an image region and a character's portion region which have been separated from each other is able to minimize the loss of character information and reduce file volumes.

By the way, for reading the above color document image (original), a color sensor is generally used, which has a reading unit with a light reception window at which primary color filters of red, green and blue are placed. This color sensor is for example composed of a 3-line CCD sensor with three line sensors each of which has a light reception window on which each of the filters is placed. Further, black characters used in ordinals are also read out with color separation by means of the three primary color filers. After this reading process, based on rates of signal components of red, green and blue, processing for the black characters which are achromatic colors is carried out.

In using this three-line CCD sensor, three are differences among physical distances between each of the line sensors and an image portion to be read out, whereby images cannot be read out from the same image portion at the same time. To compensate this difficulty, the processing, which is called line-to-line correction, is performed, with which there are provided bits of image information equivalent to the condition that each sensor reads out the image information from the same portion. In this processing, as long as each sensor reads at a constant speed in scanning, the line-to-line correction readily produces image information at the same portion.

However, if fluctuations occur in the reading speed of one or more sensors, the line-to-line correction cannot produce mutual superposition of red, green, and blue information in a precise manner. Accordingly, even when one line is depicted in only black, both edges of the line are obliged to be depicted in colors, whereby the black line cannot be expressed in back. With consideration of this situation, only an achromatic portion of the line can be picked up. But this pick-up process makes the black line thin, or, causes thin spots, discontinuities, or other errors, thus giving rise of a problem of lowering quality in the depiction.

### SUMMARY OF THE INVENTION

According to the present invention, there are provided an image reading apparatus and an image forming apparatus which make it possible that, for reading a document image optically using plural line sensors, read-out image data is compressed well while still suppressing an amount of pieces of information, and the read-out image data provide an increased depiction quality when they are printed.

One aspect of the present invention provides an image reading apparatus optically reading a document image to produce image data of the document image, comprising: a first line sensor performing the optical reading and having a predetermined number of pixels; a second line sensor performing the optical reading and having the number of pixels larger than the predetermined number of pixels; first and second compression units applying compression to both of first image information outputted from the first line sensor and second image information outputted from the second line sensor, the compression applied to the first image information and the compression applied to the second image information being different from each other; and a synthesizer mutually synthesizing the first and second image information individually compressed by the first and second compression units to produce the image data of the document image.

Another aspect of the present invention provides an image reading apparatus optically reading a document image to produce image data of the document image, comprising: a first line sensor performing the optical reading and having a predetermined resolution; a second line sensor performing the optical reading and having a resolution higher than the predetermined resolution; a producer that, by using both of first image information outputted from the first line sensor and second image information outputted from the second line sensor, produces third image information reflecting resolution of the second image information; first and second compression units applying compression to both of the first image information outputted from the first line sensor and the third image information outputted from the producer, the compression applied to the first image information and the compression applied to the third image information being different from each other; and a synthesizer mutually synthesizing the first and third image information individually compressed by the first and second compression units to produce the image data of the document image.

Still, another aspect of the present invention provides an image forming apparatus comprising an image reading apparatus optically reading a document image to produce image data of the document image and image forming means forming an image using the image data produced by the image reading apparatus, the image reading apparatus comprising: a first line sensor performing the optical reading and having a predetermined resolution; a second line sensor performing the optical reading and having a resolution higher than the predetermined resolution; a producer that, by using both of first image information outputted from the first line sensor and second image information outputted from the second line sensor, produces third image information reflecting resolution of the second image information; first and second compression units applying compression to both of the first image information outputted from the first line sensor and the third image information outputted from the producer, the compression applied to the first image information and the compression applied to the third image information being different from each other; and a synthesizer mutually synthesizing the first and third image information individually compressed by the first and second compression units to produce the image data of the document image.

Still, another aspect of the present invention provides an image reading method of optically reading a document image to produce image data of the document image, the method comprising steps of: using both of first image information outputted from a first line sensor performing the optical reading and having a predetermined resolution and second image information outputted from a second line sensor performing the optical reading and having a resolution higher than the predetermined resolution so as to produce third image information reflecting resolution of the second image information therein; applying compression to both of the first and third image information respectively, the compression applied to the first image information and the compression applied to the third image information being different from each other; and synthesizing the compressed first image information and the compressed third image information with each other so as to produce the image data of the document image.

### BRIEF DESCRIPTION OF THE DRAWINGS

In the accompanying drawings:

FIG. 1 is an outlined schematic view exemplifying a scanner which serves as an image reading apparatus according to the present invention, the view mainly showing an optical system of the apparatus;

FIG. 2 is an explanatory view pictorially showing the configuration of a 4-line CCD sensor mounted in the scanner according to the embodiment;

FIG. 3 is a timing chart explaining operations carried out by the 4-line CCD sensor;

FIG. 4 is a block diagram explaining the electric configuration of the scanner according to the embodiment, the configuration mainly showing a control substrate incorporated in the scanner;

FIG. 5 is a block diagram outlining data compression included image processing, which is carried out by the control circuit;

FIG. 6 is a view conceptually showing a conventional known art which illustrates extraction of image information and character information, which are mutually separated, from a document image;

FIG. 7 is a view conceptually showing the present invention which illustrates individual extraction of image information and character information from two kinds of document images which are the same contents but have been read out at different resolution levels;

FIG. 8 is a view explaining production of achromatic characters, which is carried out in an embodiment reduced into practice according to the present invention;

FIG. 9 is a view explaining production of achromatic characters which is based on an example of the conventional technique;

FIG. 10 is an outlined schematic view exemplifying a digital copying machine serving as an image forming apparatus according to the present invention, the view mainly showing the mechanical structure of the apparatus;

FIG. 11 is a block diagram explaining an outlined electronic configuration of the digital copying machine; and

FIG. 12 is a block diagram of part of the digital copying machine, which outlines image processing including compression as a main part thereof.

### DETAILED DESCRIPTION OF PREFERRED EMBODIMENTS

Hereinafter, with reference to accompanying drawings, one embodiment of the present invention will now be described.

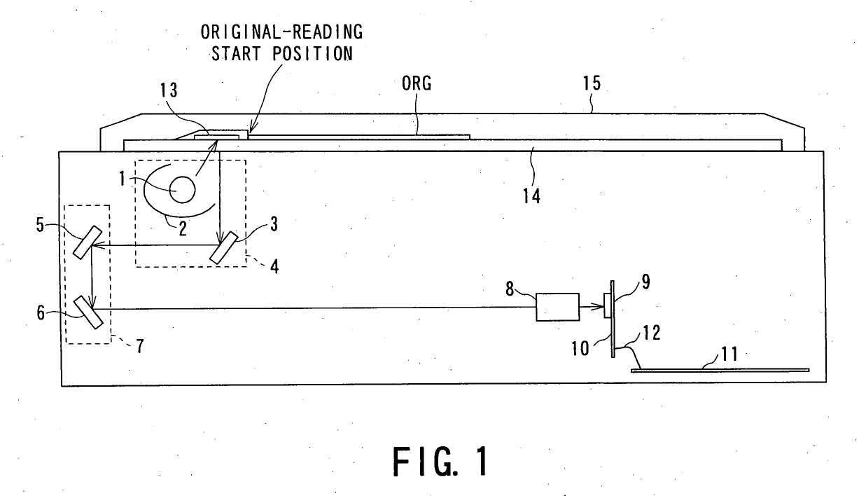

FIG. 1 shows an outlined configuration of an image reading apparatus according to the present invention, in which an optical system of the apparatus is mainly shown. This image reading apparatus, which is also called “scanner,” is configured to read, line by line, image information from an original (manuscript) that provides a document image, that is, an object to be read.

The configuration and operations of this image reading apparatus (hereinafter referred to as a “scanner”) will now be described concretely by using FIG. 1. As shown therein, this scanner comprises a light source 1 radiating light to an original Org, a reflector 2 adjusting a light distribution characteristic for the purpose of evenly radiating the light onto the original Org, a first mirror 3 receiving reflected light from the original Org, a second mirror 5 receiving reflected light from the first mirror 3, a third mirror 6 receiving reflected light from the second mirror 3, and a condenser 8 that causes the reflected light from the second mirror 6 to form an image on an image forming plane of a 4-line CCD sensor 9 which will be described below. In addition, the scanner comprises, as described above, the 4-line CCD (charge coupled device) sensor 9 that converts light energy image-formed by the condenser 8 to electric charges with the help of photoelectric transfer and outputs in sequence image-formed image data as electric signals, a CCD sensor substrate 10 on which the 4-line CCD sensor 9 is mounted, a control substrate 11 with circuitry for performing a variety of types of processing on CCD output signals provided by the CCD sensor substrate 10, a harness 11 mutually connecting, in an electric manner, the CCD sensor substrate 10 and the control substrate 11, an original table glass 14 on which a white reference plate 13 and the original Org are mounted, and an original pressing cover 15.

Of these components, the light source 1, the reflector 2 and the first mirror 3 compose a member called a first carriage 4, while both of the second mirror 5 and the third mirror 6 compose a member called a second carriage 7. For reading the original Org placed on the original table glass 14, the first carriage 4 is driven to move from the left to the right in FIG. 1 by drive means which is not shown therein. During the movement of the first carriage 4, the second carriage 7 is also moved in the same direction as the movement of the first carriage 4 such that a light path length does not change. The light path length corresponds to a distance between the original Org and the image-forming plane of the 4-line CCD sensor 9. In these movements, the second carriage 7 is set to move at a speed of which value is half the moving speed of the first carriage 4.

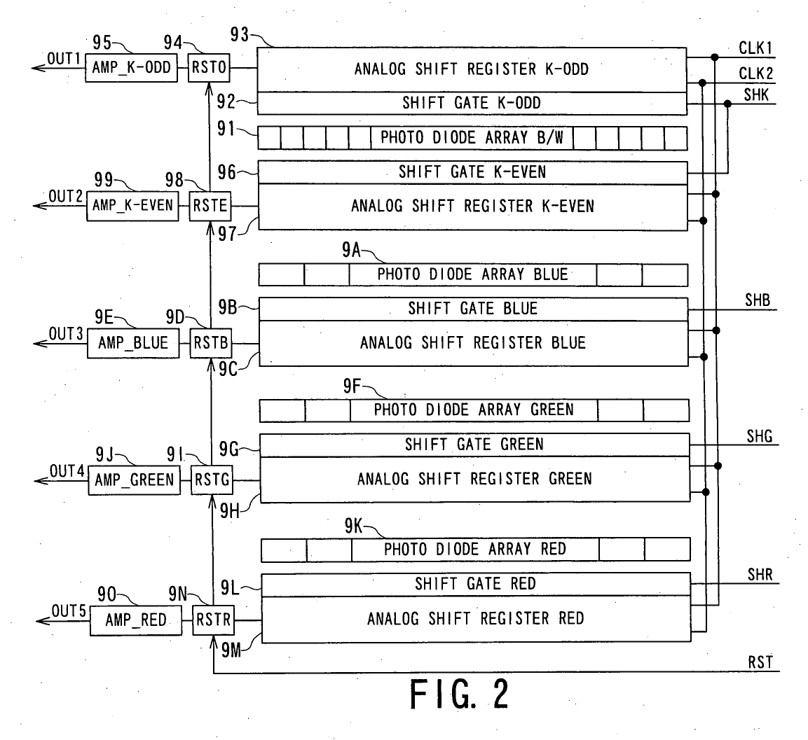

FIG. 2 outlines the configuration of the 4-line CCD sensor 9. This sensor 9 has four line sensor portions consisting of a monochrome-reading line sensor portion, a blue-reading line sensor portion, a green-reading line sensor portion, and a red-reading line sensor portion.

Of these, the monochrome-reading line sensor portion has a photo diode array B/W 91 with no color filter placed a light reception window thereof, a shift gate K-ODD 92, an analog shift register K-ODD 93, a reset circuit RSTO 94, an output-stage amplifier AMP_K-ODD 95, a shift gate K-EVEN 96, an analog shift register K-EVEN 97, a reset circuit RSTE98, and an output-stage amplifier AMP_K-EVEN 99. The shift gate K-ODD 92 is for transferring electric charge of each of odd-number-th pixels, which is converted by the photo diode array B/W 91, to the analog shift register K-ODD 93 placed adjacently to the array. The analog shift register K-ODD 93 transfers the electric charge sequentially to the output side thereof. The reset circuit RSTO 94 receives the electric charge outputted from the analog shift register K-ODD 93 in order to restore the electric charge to a reference potential pixel by pixel. Further, the shift gate K-EVEN 96 is for transferring electric charge of each of even-number-th pixels, which is converted by the photo diode array B/W 91, to the analog shift register K-EVEN 97 placed adjacently to the array. The analog shift register K-EVEN 97 transfers the electric charge sequentially to the output side thereof. The reset circuit RSTE 98 receives the electric charge outputted from the analog shift register K-EVEN 97 in order to restore the electric charge to a reference potential pixel by pixel.

The blue-reading line sensor portion has a photo diode array BLUE 9A with a blue filter placed at a light reception window of the array, a shift gate BLUE 9B, an analog shift register BLUE 9C, a reset circuit RSTB 9D, and an output-stage amplifier AMP_BLUE 9E. The light reception window serves as a plane to receive the light. In the figure, the blue filter is implicitly expressed as part of the array 9A. The shift gate BLUE 9B is for transferring electric charge of each pixel, which is converted by the photo diode array BLUE 9A, to the analog shift register BLUE 9C placed adjacently to the array. The analog shift register BLUE 9C transfers the electric charge sequentially to the output side thereof. The reset circuit RSTB 9D receives the electric charge outputted from the analog shift register BLUE 9C in order to restore the electric charge to a reference potential pixel by pixel.

The green-reading line sensor portion has a photo diode array GREEN 9F with a green filter placed a light reception window of the array, a shift gate GREEN 9G, an analog shift register GREEN 9H, a reset circuit RSTG 9I, and an output-stage amplifier AMP_GREEN 9J. The light reception window serves as a plane to receive the light. In the figure, the blue filter is implicitly expressed as part of the array 9F. The shift gate GREEN 9G is for transferring electric charge of each pixel, which is converted by the photo diode array GREEN 9F, to the analog shift register GREEN 9H placed adjacently to the array. The analog shift register GREEN 9H transfers the electric charge sequentially to the output side thereof. The reset circuit RSTG 9I receives the electric charge outputted from the analog shift register GREEN 9H in order to restore the electric charge to a reference potential pixel by pixel.

Moreover, the red-reading line sensor portion has a photo diode array RED 9K with a red filter placed a light reception window of the array, a shift gate RED 9L, an analog shift register RED 9M, a reset circuit RSTR 9N, and an output-stage amplifier AMP_RED 9O. The light reception window serves as a plane to receive the light. In the figure, the blue filter is implicitly expressed as part of the array 9K. The shift gate RED 9L is for transferring electric charge of each pixel, which is converted by the photo diode array RED 9K, to the analog shift register RED 9M placed adjacently to the array. The analog shift register RED 9M transfers the electric charge sequentially to the output side thereof. The reset circuit RSTR 9N receives the electric charge outputted from the analog shift register RED 9M in order to restore the electric charge to a reference potential pixel by pixel.

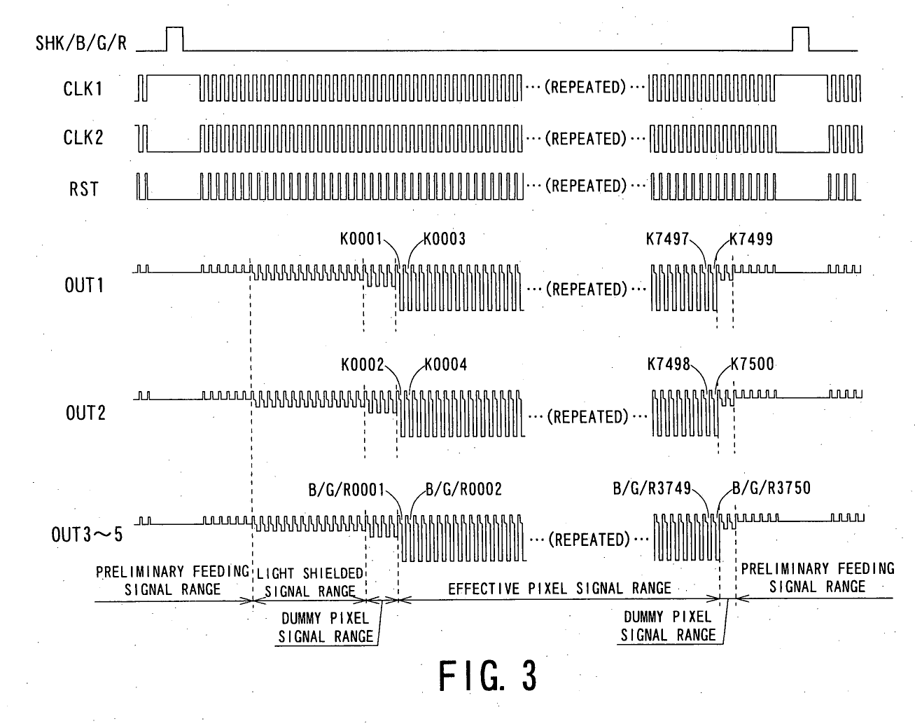

The foregoing four line sensor portions outputs signals (output signals) OUT 1-OUT5, respectively, each of which, as shown in FIG. 3, includes a train of signals containing first preliminary feeding signals, light-shielded signals, first dummy pixels signals, effective pixel signals, second dummy signals and second preliminary feeding signals, which are lined up sequentially in time. Of these signals, the first and second preliminary feeding signals are rows of signals created in no electric charge condition (because there are arranged no photodiodes therein), through those preliminary feeding signals makes each analog shift register operative. The light-shielded signals are a row of signals providing a reference output of the CCD sensor and are outputted from areas of the light reception window which are covered by aluminum members not to allow the light to come into those areas, though there are arranged photodiodes in those areas. The effective pixel signals are a row of signals produced depending on read information showing images. Further, the first dummy pixel signals serve as a row of signals linking both of the rows of the light-shielded signals and the effective pixel signals, while the second dummy pixel signals serve as a row of signals linking both of the rows of the effective pixel signal and the second preliminary feeding signals.

The 4-line CCD sensor 9 shown in FIG. 2 is characteristic of a configuration where there is a difference in the number of effective pixels between the photo diode array B/W 91 and each of the photo diode array BLUE 9A, the photo diode array GREEN 9F, and photo diode array RED 9L. To be specific, the number of effective pixels of the photo diode array B/W 91 is two times larger than that of each of the he photo diode array B/W 91 and each of the photo diode array BLUE 9A, the photo diode array GREEN 9F, and photo diode array RED 9L. This means that, for example, if an original having a width of 297 mm is read out by using the photo diode array B/W 91 whose resolution is set to be 600 dpi (dot per inch), a resolution of 300 dpi should be given each of the photo diode array BLUE 9A, the photo diode array GREEN 9F, and photo diode array RED 9L.

There is another feature that, as shown in FIG. 3, clock signals CLK1 and CLK2 controlling each analog shift register have phases which are opposite to each other. These clock signals CLK1 and CLK2 stop during a period of time composed of both of a period of “H” corresponding to logical “1” and predetermined periods of time that precede and succeed the period of “H,” respectively. During the period of “H,” synchronization signal SHK controlling both of the shift gate K-ODD 92 and the shift gate K-EVEN 96, a synchronization signal SHB controlling the shift gate BLUE 9B, a synchronization signal SHG controlling the shift gate GREEN 9G, and a synchronization signal SHR controlling the shift gate RED 9L are assigned to opening the gates, respectively. Though the stop period is set to the period of “H” corresponding to logical “1” in the present embodiment, this is not a definitive list. Depending on types of CCD sensors to be used, the stop period may also be set to a period of “L” corresponding to logical “0.”

The 4-line CCD sensor that is configured as above is able to operate in the same way as that detailed in, for example, Japanese Patent Laid-open Publication No. 2004-289245.

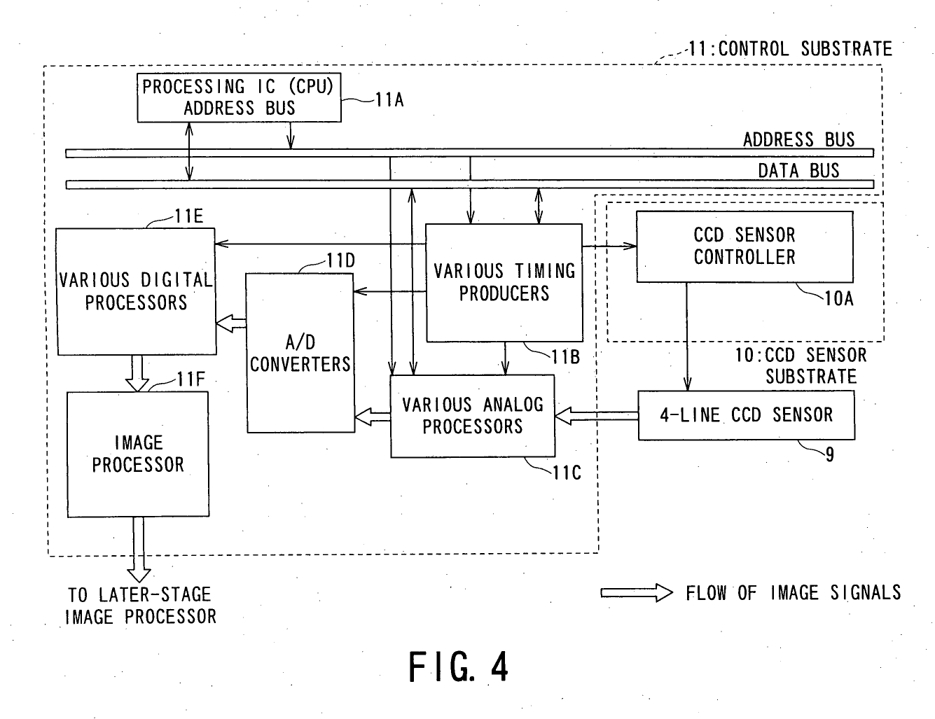

With reference to FIG. 4, the circuitry of the control substrate 11 and sensor substrate 10 will now be described.

The control substrate 11 is formed to have a processing IC 11A that is for example a CPU, various timing producers 11B producing various types of timing signals, various analog processors 11C, A/D converters 11D converting analog signals to corresponding digital signals, various digital processors 11E, and an image processor 11F. Among them, the various timing producers 11B have the configuration in which timing signals required for drive of a later-descried CCD sensor controller 10A of the CCD sensor substrate 10, the various analog processors 11C, the A/D converters 11D, and the various digital processors 11E.

On the other hand, on the CCD sensor substrate 10, the foregoing CCD sensor controller 10A are formed, which comprises a not-shown voltage conversion circuit for driving the 4-line CCD sensor 9, buffers, and other circuit components. This CCD sensor controller 10A is electrically coupled with the 4-line CCD sensor 9 to drive the sensor 9. The 4-line CCD sensor 9 reads the pixels of an image as image signals and provided the image signals to the various analog processors 11C on the control substrate 11.

The image signals outputted from the 4-line CCD sensor 9, which are shown as output signals OUT1-OUT5 in FIG. 3, include an offset potential having a specified amplitude (which is defined as a DC output voltage for the CCD sensor device) and are outputted in the form of downward-directional pulsed voltages whose amplitudes are proportional to amounts of incident light. In the example shown in FIG. 3, the downward direction which can be shown in the output signals OUT1-OUT5 is a direction to 0-volts that is a reference voltage. In the case of this signal waveform, the offset potential, a dark output voltage generated in the light shielded area, and reset noise generated pixel by pixel are unnecessary signal factors. Hence, in the various analog processors 11C, the output signals OUT1-OUT5 are subjected to removal of the unnecessary signal factors of the output signals OUT1-OUT5 to produce effective signal components, and then to adjustment of the amplitudes of the effective signal components so that those amplitudes meet the input range of the next-stage AD converters 11D. The output signals OUT1-OUT5 that have experienced the amplitude adjustment are provided, as image signals, to the AD converters 11D, where the output signals are converted to digital signals. The digitized image signals are then subjected to processing carried out by the various digital processors 11E, the processing including shading correction treating high-frequency distortion due to fluctuations in the sensitivity of each pixel of each photo diode array, low-frequency distortion due to the aberration of the condenser 8, and the unevenness of light-emitting distribution of the light source 1. By the processing at the various digital processors 11E, the output signals are converted to normalized image signals. Because of being known, the shading correction is omitted from being detailed.

The above processing makes it possible that the outputs from the 4-line CCD sensor 9 are set to “0” when the light source 1 is turned off and to “255” when the light source 1 is turned on so that the white reference plate 13 is read out. The resolution of the A/D converters 11D attains “255” for 8 bits and “1023” for 10 bits.

In the various digital processors 11E, in addition to the foregoing various types of digital processing, delay processing is performed which is called “line-to-line correction.” The reason why this correction is needed is that, as pictorially shown in FIG. 2, the photo diode arrays B/W 91, BLUE 9A, GREEN 9F, and RED 9L are physically separated from each other so that the four photo diode arrays cannot read the same location on an original at the same time. Thus, the digital signals from the four photo diode arrays B/W 91, BLUE 9A, GREEN 9F, and RED 9L are sent to the various digital processors 11E, where those digital signals undergo the line-to-line correction. That is, delay processing is performed with the digital signals line by line, whereby correspondence is achieved on the line basis among reading positions of the respective photo diode arrays.

The digital signals which have been experienced the processing at the various digital processors 11E are then sent to the image converters 11F to which the present invention is applied. In the image processor 11F, the digital signals are subjected to compression, that is, compressing the digital-amount image signals. Those compressed image signals (digital signals) are then provided to the next-stage image processing system for processing images thereat.

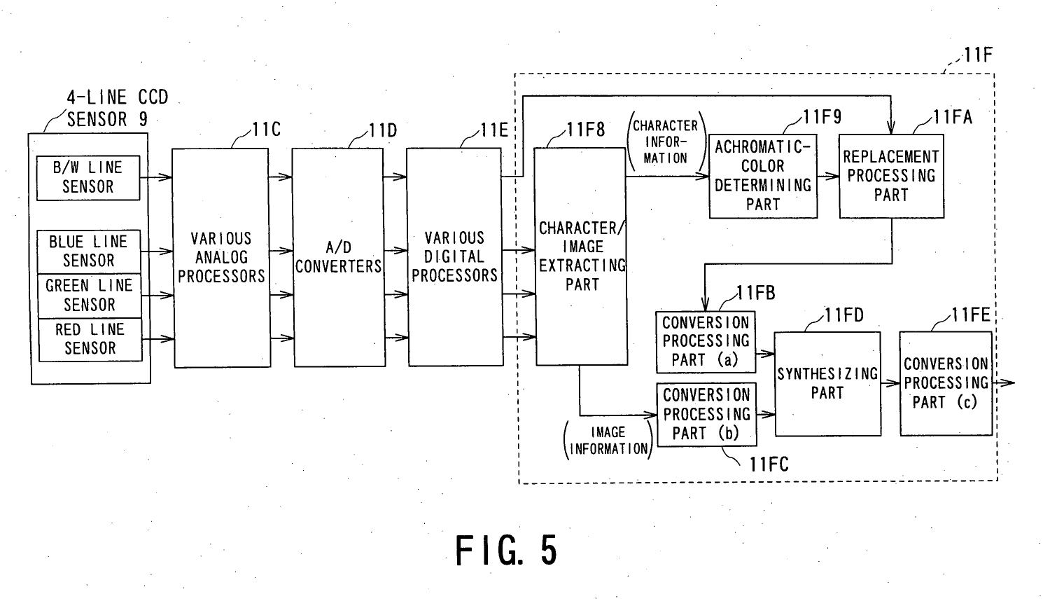

As shown in FIG. 5, the image processor 11F has the configuration unique to the present invention that is adaptable to the 4-line CCD sensor 9. Specifically, the 4-line CCD sensor 9 is configured to have both of a known 3-line CCD sensor and a monochrome line sensor additionally installed, so that the sensor 9 comprises circuitry coping with those configurations, the circuitry including a character/image extracting part 11F8, an achromatic-color determining part 11F9, a replacement processing part 11FA, a conversion processing parts 11FB and 11FC, a synthesizing part 11FD, and another conversion processing part 11FE.

The image signals outputted from the 4-line CCD sensor 9 are, as described before, converted into normalized digital signals by the various analog processors 11C, A/D converters 11D, and various digital processors 11E, and the normalized digital digitals are provided to the image processor 11F. Of these, the image signals normalized based on the output signals from the color-reading photo diode arrays BLUE 9A, GREEN 9F, and RED 9L are outputted to the character/image extracting part 11F8. In parallel with this signal output, the image signals normalized based on the output signals from the photo diode array B/W 91 are outputted to the replacement processing part 11FA.

The character/image extracting part 11F8, achromatic-color determining part 11F9, and replacement processing part 11FA operate cooperatively to divide image signals that are read from one sheet of original into pieces of line-art information (line-art regions) composed of thin lines of characters and others and pieces of image information (image regions) which are for example a picture composed of halftones.

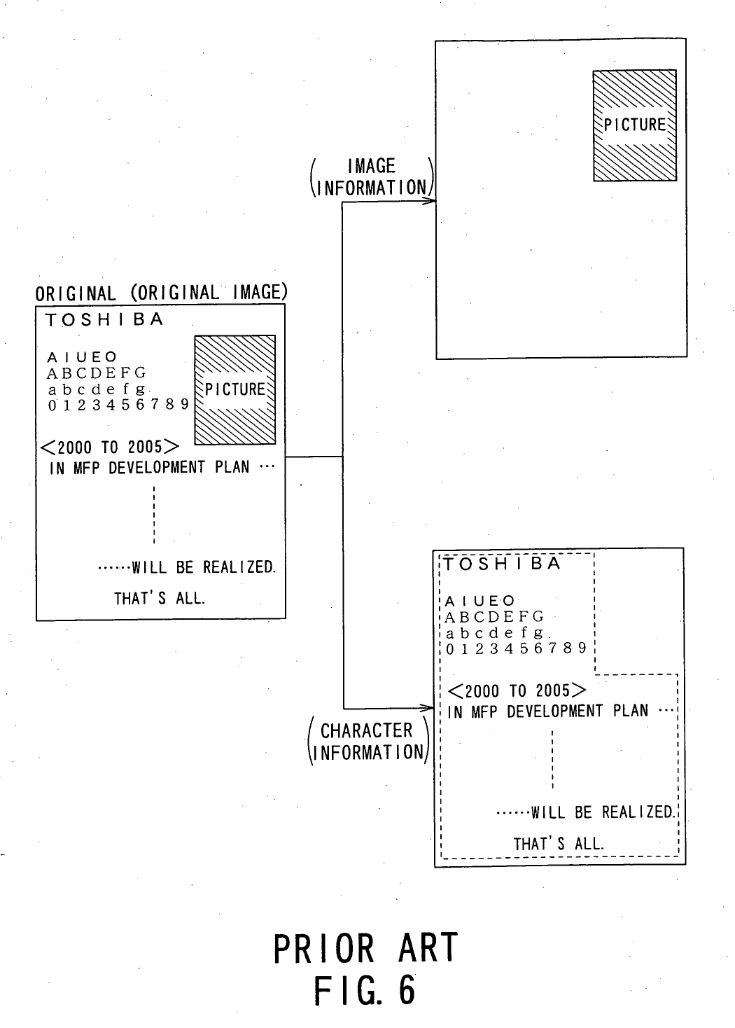

In order to explain the concept of this division, for the sake of comparison, a conventional division will now pictorially be shown in FIG. 6. The division according to this concept shown in FIG. 6 has already been known, which is based on processing to extract, respectively, line-art information and image information from the same image signals that compose one sheet of original.

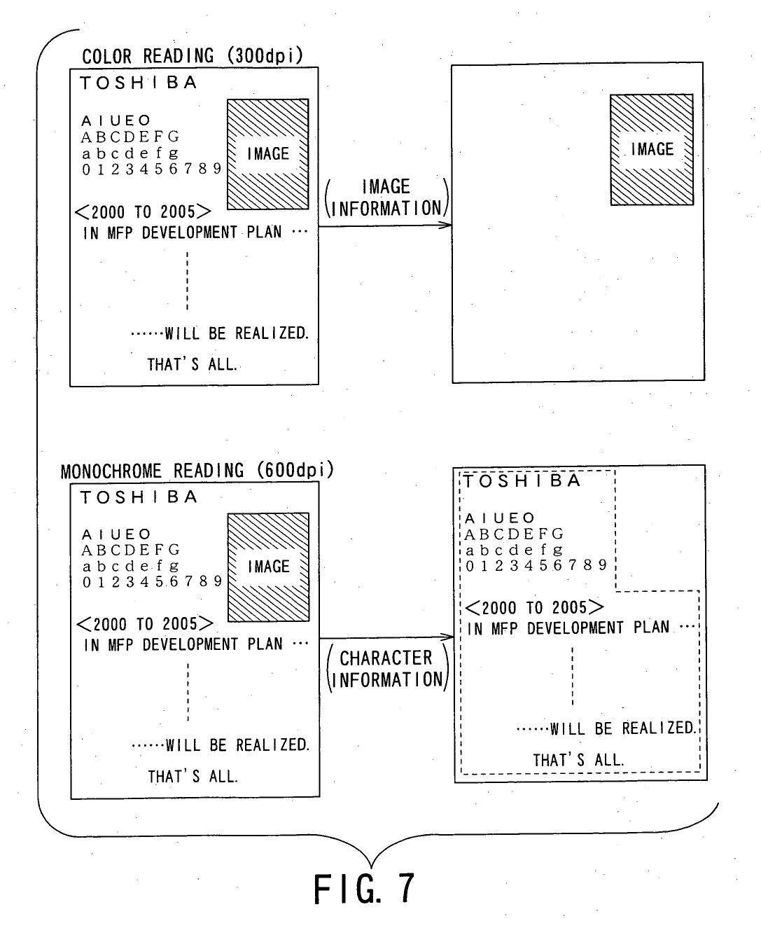

In contrast, though the division carried out in the present embodiment looks like the same as the conventional in terms of a formal view for divided results, how to perform the division differs from the conventional. The processing which is in accordance with the concept of the division described above and is carried out by the character/image extracting part 11F8, achromatic-color determining part 11F9, and replacement processing part 11FA in an cooperative manner, is shown in FIG. 7. That is, conceptually, the same image information written in one sheet of original is prepared as two pairs of image signals are prepared. From each of these two pairs of image signals, a line-art region and an image region are extracted, respectively. Of these, the image information (image regions) is extracted using color image signals read by the photo diode array BLUE 9A, GREEN 9F and RED 9K for color reading, which are less in the number of pixels (i.e., low resolution). In contrast, the character information is extracted by using a monochrome image signal ready by the photo diode array B/W 91 whose number of pixels are greater (i.e., high resolution). By way of example, a resolution of 300 dpi is assigned to color image information and a resolution of 600 dpi is assigned to the monochrome image information, respectively.

The division based on the present embodiment will now be detailed more. From color image signals read by the color-reading photo diode array BLUE 9A, GREEN 9F and RED 9K, the character/image extracting part 11F8 extracts, pixel by pixel, line-art information composed of thin lines such as characters and image information which is for example pictures and is composed of halftones. Of the image and character information based on the resultant color image signals, the image information is directly supplied to the conversion processing part 11FC, while the character information is first supplied to the achromatic-color determining part 11F9. Hence the achromatic-color determining part 11F9 applies achromatic-color determination to this character information obtained from the color image signals. This achromatic-color determination can be performed with the use of conventionally known techniques. For example, a ratio among color component of blue, green and red contained in the image signals composing the character information can be used for determining whether the character information is a chromatic color or an achromatic color. For the achromatic color, the ratio among blue, green and red components are the same. However, in an actual case, noise component may be contained in the components, which means that the exactly same values of the color components cannot be attained. Therefore, it is necessary to have a certain degree of allowance in obtaining the ratio. For example, for a 8-bit resolution, it can be determined whether or not the values of the color components are consistent with each other within 255LSB±5LSB. If this determination reveals an affirmative answer, the color signal can be regarded as being achromatic.

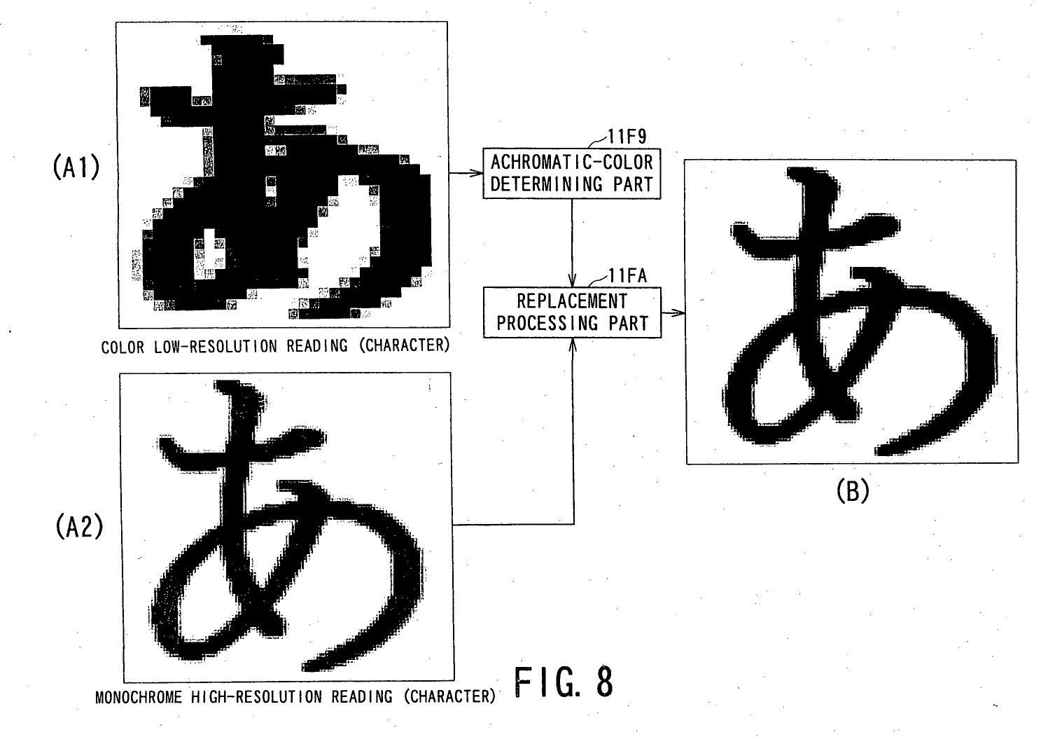

When the achromatic-color determining part 11F9 determines that information about pixels composing the character information shows an achromatic color, the pixel information is provided to the replacement processing part 11FA. To this replacement processing part 11FA, as described before, high-resolution image signals are given from the photo diode array B/W 91. Thus, as pictorially shown in FIG. 8, the replacement processing part 11FA replaces pixels (an area) composed of the character information determined to be achromatic, with monochrome image information read by the photo diode array B/W 91. In other words, each pixel, which is indicative of achromatic character information resulting from the color image signals acquired at a relatively low resolution, is replaced with monochrome image information whose resolution is higher than that of the achromatic character information. As a result, even when the edges of characters are colored due to positional shifts in color synthesis, coloring at those edges are removed from the final output, whereby only the achromatic-color areas are left as the final output. And those achromatic-color areas are, pixel by pixel, subject to mapping of monochrome image information.

Accordingly, as shown in FIG. 7, the image information is separated from the color image signals read by the color-reading photo diode array BLUE 9A, GREEN 9F and RED 9K, whilst, in the view of equivalency, the line-art information is resulted in that it is separated from the monochrome image information read by the photo diode array B/W 91. Thus as to the achromatic line-art information, the monochromatic information is still kept as it is.

In this way, the monochromatic line-art information separated through the cooperative operations of the character/image extracting part 11F8, achromatic-color determining part 11F9, and replacement processing part 11FA is sent to the conversion processing part 11FB. This part 11FB performs reversible compression processing (such as JBIG compression) which is suitable to line-art including characters. In contrast, the conversion processing part 11FC receives the image information extracted by the character/image extracting part 11F8 and performs nonreversible compression processing (such as JPEG compression) which is high in data compression ration and is suitable to images. Hence, as a whole, the compression which is suitable for the kind of information provided by an object to be processed is performed individually, so that a high compression efficiency is maintained.

Both of the character information and the image information which are individually compressed at the two conversion processing parts 11FB and 11FC are then provided to the synthesizing part 11FD to be mutually synthesized at every pixel. The thus-synthesized information is then provided to the next conversion processing part 11FE as digital image signals, and subject to necessary conversion processing at the part 11FE.

As described, in the scanner according to the present embodiment, the pixels found to be achromatic are always replaced by monochromatic pixel values which are higher in resolution. Hence, for the line-art information such as characters, deteriorations in images, which appear for example to be thin, thin spots, or discontinuities, and loss of pieces of information can be suppressed or prevented, thus improving quality in printing and other depictions.

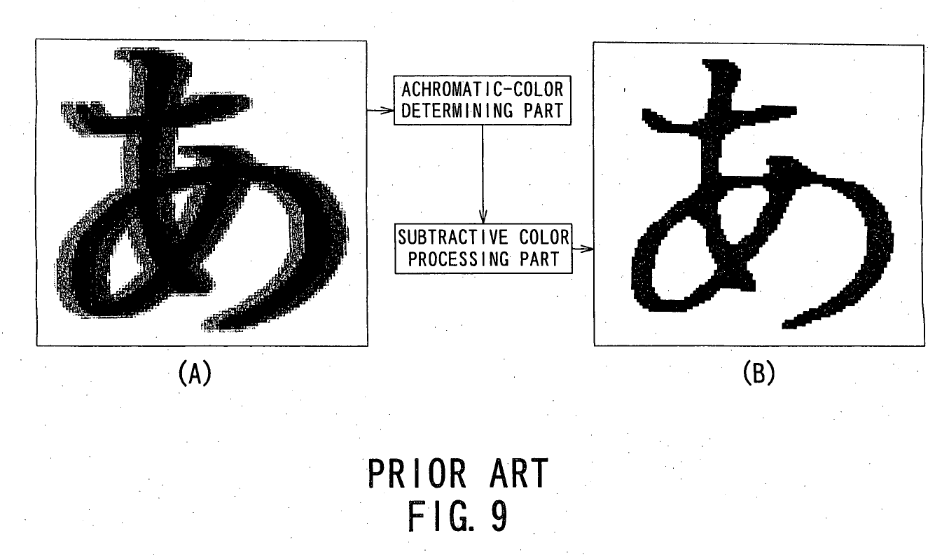

This advantage can be more clarified if compared with the conventional technique with the help of some figures. In general, in cases where there occurs unevenness or fluctuations in a speed at which an original Org is read out, color synthesizing operations (color superposition) for blue, green and red, which is carried out as the line-to-line correction at the various digital processors 11E, cannot be performed at high precision. In addition, though already been described, as exemplified in FIG. 9(A), there may appear colored portions at edges of a character, which is due to positional shifts in the synthesizing operations. In the conventional, to cope with this problem, the determination for the achromatic color is performed, in which only a portion that causes the color signals of blue, green and red to be consistent with each other within a range of tolerances is determined to be a black-character portion. This determined result is then subjected to subtractive color processing to enhance contrast of an image. As a result, as shown in FIG. 9(B), thinning, thin spots, or discontinuities of a character may occur, which deteriorate images, in which there may be loss of pieces of information from images.

By contrast, in the case of the scanner according to the present invention to which the present invention is applied, determining the achromatic color is first applied to line art, and then, instead of the subtractive color processing, the replacement processing based on monochrome image information, which is higher in resolution, is performed. As will be clear from the comparison between FIG. 8(B) and FIG. 9(B), the occurrence of thinning, thin spots, discontinuities or others of a character are prevented or suppressed with steadiness.

Some image forming apparatuses in which the scanner according to the foregoing embodiment is mounted will now be exemplified.

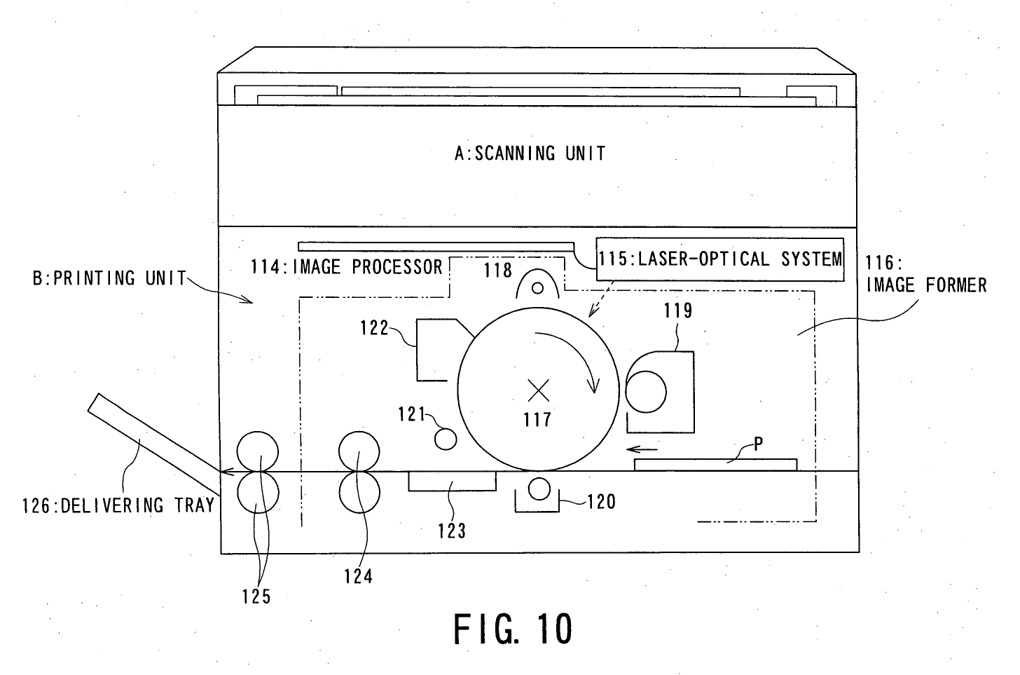

In FIG. 10, a digital copying machine serving as such an image forming apparatus is schematically shown. This digital copying machine is equipped with a scanning unit A which serves as the image reading apparatus and a printing unit B which prints images on paper, which are explained using FIG. 1.

In the scanning unit A, a normalized image signal is outputted from the image processor 11F shown in FIG. 4. This image signal enters an image processor 114 equipped in the printing unit B. This image processor 114 operates to execute various types of processing, which include storage of the image signal in a temporally memory such as a not-shown page memory, scaling up/down processing, and conversion of image signals composed of components of colors consisting of blue, green, and red to signals for four colors consisting of yellow, magenta, cyan and black, which constitute a format that adapts to image formation. The image signals converted into the four color components are the formed into control signals, which are provided to semiconductor lasers contained in a next-stage laser-optical system 115.

The printing unit B has an image former 116, which is provided with a photosensitive drum 117, electrostatic charger 118, developing unit 119, transfer charger 120, flaking charger 121, cleaner 122, paper delivering mechanism 123, fixing unit 124, paper delivering rollers 125, and other components. These components realize the printing processes based on a conventionally known electrophotography technique, with the result that printing is made on sheets of paper P, which are delivered by the paper delivering mechanism 123. An alternative structure with no cleaner 122 is also possible, because transferring the developer to the paper P has been improved in efficiency in recent years.

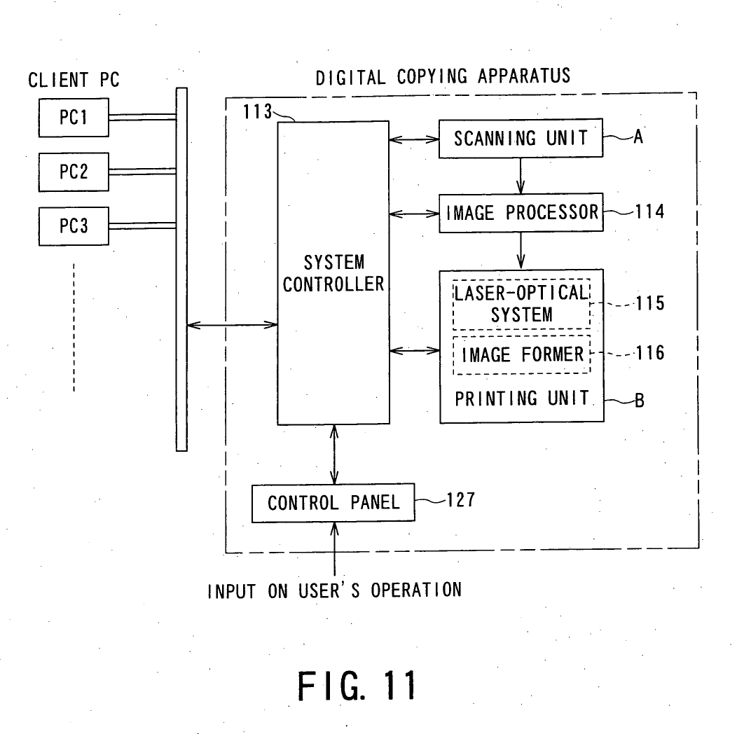

FIG. 11 schematically shows the electric configuration of the foregoing digital copying machine. This configuration includes a system controller 113, which is a member to control the whole present system, having an interface I/F (not shown) for controlling the scanning unit A, an image processor 114, and the printing unit B and for transmitting/receiving data via a network. The image signal outputted from the scanning unit A is provided to the image processor 114, where the image signal is subjected to various types of processing, before the resultant image signal enters the printing unit B. In the case that reading is made for the purpose of copying the original Org, the processing is carried out as above. However, when the reading of the original Org is made for filing, the image signal outputted from the scanning unit A enters the system controller 113, from which a compressed image signal is transferred to an external client PC via a network. Whether a desired process is copying or filing is decided in response to a user's command to a control panel 127 which is in charge of such a decision.

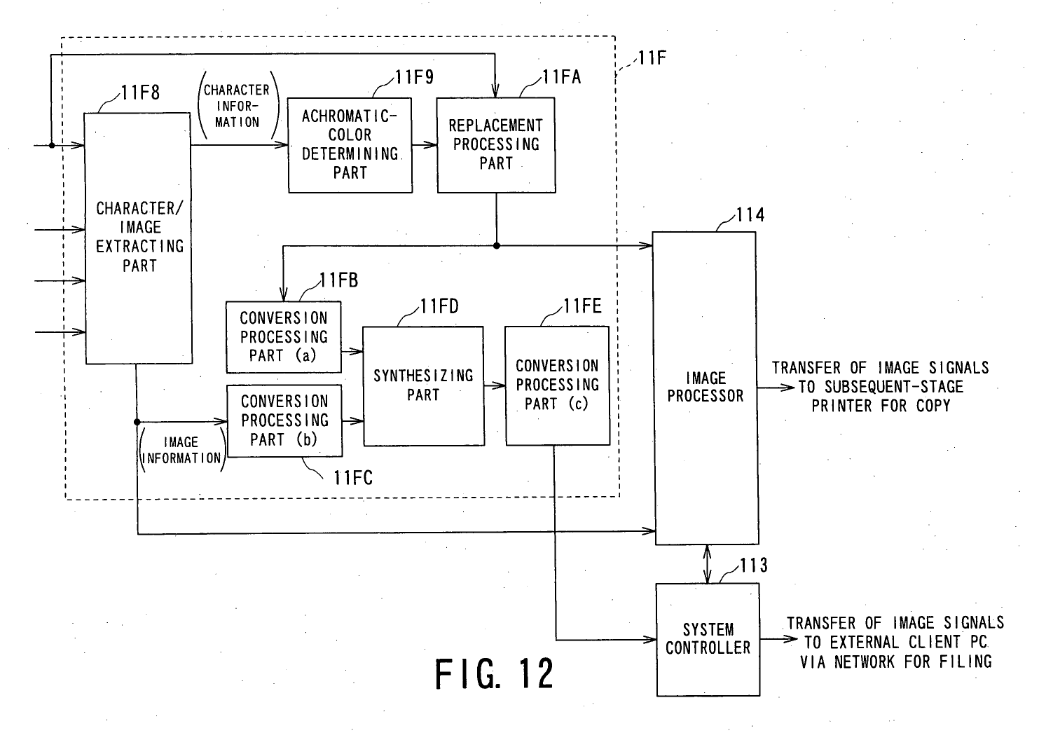

The flow of the image signals for copying and filing will now be descried with reference to FIG. 12. For copying, it is desired that the original Org be reproduced faithfully, so that compression which causes deterioration in images will not be performed. Specifically, both of achromatic image information separated by the character/image extracting part 11F8, achromatic-color determining part 11F9, and replacement processing part 11FA and color image information extracted by the character/image extracting part 11F8 are mutually synthesized and subjected to various types of processing, before being transferred to the printing unit B.

On the other hand, when filing is desired, it is necessary to file information on the original Org without losing it and to reduce an amount of data to be stored as files. Thus achromatic image information processed through the character/image extracting part 11F8, achromatic-color determining part 11F9, and replacement processing part 11FA is sent to the conversion processing part 11FB, in which the information undergoes compression. Meanwhile, color image information extracted at the character/image extracting part 11F8 is then provided to the conversion processing part 11FC, in which the information also undergoes compression. Both of the monochromatic line-art information and the color image information are then synthesized mutually by the synthesizing part 11FD. This is further followed by processing at a conversion processing part 11F, where the synthesized information is compressed/converted to standard files which can be outputted externally. The file data are then provided to the system controller 113. Via a not-shown external I/F part in the system controller 113, the compressed data of the files, which are formatted as being standard, are outputted to an external client PC via a network.

Moreover, when a filing command for only achromatic-color characters is issued from a user by way of the control panel 127, it is also possible to use only character information coming from the conversion processing part 11FB in order to produce files to be outputted externally, without using the conversion processing part 11FC.

In the present example, the image forming apparatus has been descried as if for mono-color copying is structured, which is typically shown in FIG. 10. However, it goes without saying that the developing unit 119 can be used in color copying (plural colors) for four colors consisting of yellow, magenta, cyan and black.

In this way, in the present embodiment, both of the image sensor for monochrome reading and the image sensors for color reading are used for filing a color image (original) in which characters and images are present in a mixed manner. In this filing, line-art information such as achromatic-color characters is read out by an image sensor which is dedicated to monochrome reading to have higher resolution, and the line-art information is produced from the read-out information. This avoids line-art information from being lost. By contrast, image information is read out by color image sensors which are lower in resolution, and the read-out information is subjected to production of the image information, resulting in an increase in the compression ratio.

As described, when the present invention is reduced into practice, there can be provided an image reading apparatus and an image forming apparatus, which are able to optically read a document image using a plurality of line sensors, in which read-out image data can be compressed with steadiness and an amount of pieces of information can be suppressed from increasing.

In addition, for reading a document image optically using plural line sensors, there are provided an image reading apparatus and an image forming apparatus which make it possible that read-out image data is compressed well while still suppressing an amount of pieces of information, and the read-out image data provide an increased depiction quality when they are printed.

When reading out a document image in an optical manner using plural line sensors, there are still provided an image reading apparatus and an image forming apparatus which make it possible that, even when one sensor differs in reading speed from another one, depiction quality of black lines is increased when the read-out image data is subjected to printing.

By the way, the scope of the present invention will not be limited to the configurations provided by the foregoing various embodiments, but can be reduced into practice on further various modes which involve combinations with known techniques which are readily conceivable for the person in the art, without departing from the gist of the present invention. For example, the image processor 11F including the character/image extracting part 11F8, achromatic-color determining part 11F9, and replacement processing part 11FA may be configured with a computer comprising a CPU (central processing unit) and memories, though being able to use hardware circuits such as logic circuits. For using the computer, software processing on programs implemented in the computer can be made effective to realize either the functions of the foregoing character/image extracting part 11F8, achromatic-color determining part 11F9, and replacement processing part 11FA, or, the functions on both of those components and the remaining components.

What is claimed is:

1. An image reading apparatus optically reading a document image to produce image data of the document image, comprising:
a first line sensor performing the optical reading and having a predetermined number of pixels;
a second line sensor performing the optical reading and having the number of pixels larger than the predetermined number of pixels;
first and second compression units applying compression to both of first image information outputted from the first line sensor and second image information outputted from the second line sensor, the compression applied to the first image information and the compression applied to the second image information being different from each other; and
a synthesizer mutually synthesizing the first and second image information individually compressed by the first and second compression units to produce the image data of the document image.

2. The image reading apparatus according to claim 1, wherein
the first line sensor is a 3-line CCD (charge coupled device) line censor comprising a light receiving plane and red, green and blue color filters arranged on the light receiving plane and
the second line sensor is a 1-line CCD sensor comprising a light receiving plane with no color filter arranged thereon.

3. The image reading apparatus according to claim 1, wherein
the first line sensor is a sensor optically reading a chromatic-color document image, the first image information is image data composed of chromatic colors, and
the second line sensor is a sensor optically reading an achromatic-color document image, the second image information is image data composed of achromatic colors.

4. The image reading apparatus according to claim 1, wherein
the first line sensor is a sensor optically reading a chromatic-color document image, the first image information is image data composed of monotones,
and the second line sensor is a sensor optically reading an achromatic-color document image, the second image information is image data composed of achromatic-color image data including thin lines and characters.

5. An image reading apparatus optically reading a document image to produce image data of the document image, comprising:
a first line sensor performing the optical reading and having a predetermined resolution;
a second line sensor performing the optical reading and having a resolution higher than the predetermined resolution;
a producer that, by using both of first image information outputted from the first line sensor and second image information outputted from the second line sensor, produces third image information reflecting resolution of the second image information;
first and second compression units applying compression to both of the first image information outputted from the first line sensor and the third image information outputted from the producer, the compression applied to the first image information and the compression applied to the third image information being different from each other; and
a synthesizer mutually synthesizing the first and third image information individually compressed by the first and second compression units to produce the image data of the document image.

6. The image reading apparatus according to claim 5, wherein
the first line sensor is a sensor optically reading a chromatic-color document image, the first image information is image data composed of chromatic colors, and
the second line sensor is a sensor optically reading an achromatic-color document image, the second image information is image data composed of achromatic colors.

7. The image reading apparatus according to claim 6, wherein
the first line sensor is a 3-line CCD (charge coupled device) line censor comprising a light receiving plane and red, green and blue color filters arranged on the light receiving plane and
the second line sensor is a 1-line CCD sensor comprising a light receiving plane with no color filter arranged thereon.

8. The image reading apparatus according to claim 7, wherein the producer comprises
extraction means for extracting line-work information from the first image information outputted from the first line sensor,
determining means for determining an achromatic-color region in a region to be displayed with the line-work information extracted by the extracting means; and
replacing the achromatic-color region determined by the determining means with the second image information outputted from the second line sensor so as to produce the third image information.

9. An image forming apparatus comprising an image reading apparatus optically reading a document image to produce image data of the document image and image forming means forming an image using the image data produced by the image reading apparatus, the image reading apparatus comprising:
a first line sensor performing the optical reading and having a predetermined resolution;
a second line sensor performing the optical reading and having a resolution higher than the predetermined resolution;
a producer that, by using both of first image information outputted from the first line sensor and second image information outputted from the second line sensor, produces third image information reflecting resolution of the second image information;
first and second compression units applying compression to both of the first image information outputted from the first line sensor and the third image information outputted from the producer, the compression applied to the first image information and the compression applied to the third image information being different from each other; and
a synthesizer mutually synthesizing the first and third image information individually compressed by the first and second compression units to produce the image data of the document image.

10. The image forming apparatus according to claim 9, wherein
the first line sensor is a sensor optically reading a chromatic-color document image, the first image information is image data composed of chromatic colors, and
the second line sensor is a sensor optically reading an achromatic-color document image, the second image information is image data composed of achromatic colors.

11. The image forming apparatus according to claim 10, wherein
the first line sensor is a 3-line CCD (charge coupled device) line censor comprising a light receiving plane and red, green and blue color filters arranged on the light receiving plane and
the second line sensor is a 1-line CCD sensor comprising a light receiving plane with no color filter arranged thereon.

12. The image forming apparatus according to claim 11, wherein the producer comprises
extraction means for extracting line-work information from the first image information outputted from the first line sensor,
determining means for determining an achromatic-color region in a region to be displayed with the line-work information extracted by the extracting means; and
replacing the achromatic-color region determined by the determining means with the second image information outputted from the second line sensor so as to produce the third image information.

13. An image reading method of optically reading a document image to produce image data of the document image, the method comprising steps of:
using both of first image information outputted from a first line sensor performing the optical reading and having a predetermined resolution and second image information outputted from a second line sensor performing the optical reading and having a resolution higher than the predetermined resolution so as to produce third image information reflecting resolution of the second image information therein;
applying compression to both of the first and third image information respectively, the compression applied to the first image information and the compression applied to the third image information being different from each other; and
synthesizing the compressed first image information and the compressed third image information with each other so as to produce the image data of the document image.

14. The image reading method according to claim 13, wherein
the first line sensor is a sensor optically reading a chromatic-color document image, the first image information is image data composed of chromatic colors, and
the second line sensor is a sensor optically reading an achromatic-color document image, the second image information is image data composed of achromatic colors.

15. The image reading method according to claim 14, wherein
the first line sensor is a 3-line CCD (charge coupled device) line censor comprising a light receiving plane and red, green and blue color filters arranged on the light receiving plane and
the second line sensor is a 1-line CCD sensor comprising a light receiving plane with no color filter arranged thereon.

16. The image reading method according to claim 15, wherein the step for producing the third image information comprises steps of
extracting line-work information from the first image information outputted from the first line sensor;
determining an achromatic-color region of a region to be displayed by the extracted line-work information; and
replacing the determined achromatic-color region with the second image information outputted from the second line senor so as to produce the third image information.
